(19) United States
(12) Patent Application Publication
(10) Pub. No.: US 2025/0157697 A1
(43) Pub. Date: May 15, 2025

(54) WIRE HARNESS MANUFACTURING APPARATUS AND WIRE HARNESS MANUFACTURING METHOD

(71) Applicant: Yazaki Corporation, Tokyo (JP)

(72) Inventors: Hiroyasu KOBAYASHI, Makinohara-shi (JP); Jun Yagi, Makinohara-shi (JP)

(73) Assignee: Yazaki Corporation, Tokyo (JP)

(21) Appl. No.: 18/905,351

(22) Filed: Oct. 3, 2024

(30) Foreign Application Priority Data
Nov. 13, 2023 (JP) 2023-192698

(51) Int. Cl. H01B 13/012

(52) U.S. Cl. CPC H01B 13/01236

(57) ABSTRACT

A wire harness manufacturing apparatus 1 includes a plurality of connector cups 12 having a same outer shape as each other, a sub-harness mounting plate 13 on which a plurality of sub-harnesses W1a are mounted while the connector cup 12 is attached to the connector, a plate fixing portion 14, a plurality of slide portions 15 respectively holding one-end side connectors via the connector cups 12, base end holding portions 16 holding other-end side connectors via the connector cups 12, a connector transfer mechanism 17 detaching the one-end side connector and the other-end side connector together with the connector cup 12 from the sub-harness mounting plate 13 to the slide portions 15 and the base end holding portions 16, and an electric wire processing portion 18 performing electric wire processing on electric wires stretched between the slide portions 15 and the base end holding portions 16.

### TECHNICAL FIELD

The present disclosure relates to a wire harness manufacturing apparatus and a wire harness manufacturing method for manufacturing a branch shape wire harness.

### BACKGROUND

Conventionally, an apparatus in which multiple holding members for holding wire harnesses are arranged on a flat wiring board in accordance with a branch shape has been used as a manufacturing apparatus for manufacturing a branched-shape wire harness (for example, see Patent Document 1). In this type of manufacturing apparatus, wire harnesses are manufactured by routing electric wires on the wiring board and forming the branch shape.

### RELATED ART

### Patent Document

Patent Document 1: JP2018060643A

### SUMMARY OF THE INVENTION

### Problem to be Solved by the Invention

Most of the tasks using the above-described manufacturing apparatus are performed manually by workers. On the other hand, development of an apparatus that automatically performs manufacturing task without human intervention for manufacturing wire harnesses is also underway. However, the wire harnesses assumed to be manufactured include various harness types with a wide variety of branch shapes and connector types. In order to accommodate these harness types, it is often difficult to realize a configuration that switches the holding portions of connectors and the routing mechanism of electric wires according to each type. For this reason, there are currently no specific proposals for an apparatus or a method that automatically performs manufacturing task while dealing with various harness types.

Therefore, in view of the above-described problems, it is an object of the present invention to provide a wire harness manufacturing apparatus and a wire harness manufacturing method that can automatically perform manufacturing tasks while dealing with various types of harnesses.

### Solution to Problem

In order to solve the above problems, a wire harness manufacturing apparatus includes a plurality of connector cups having a same outer shape as each other and configured to accommodate, one by one in a detachable manner, a plurality of connectors provided on one-end side and one or more connectors provided on the other-end side of a wire harness to be manufactured in which a branch shape is formed by combining a plurality of sub-harnesses, a sub-harness mounting plate on which the plurality of sub-harnesses are mounted while the connector cups are attached to the connectors included in the sub-harnesses in a detachable manner, a plate fixing portion to which the sub-harness mounting plate is attached in a detachable manner, a plurality of slide portions respectively holding, via the connector cups, a plurality of one-end side connectors that are provided on the one-end side among the plurality of connectors, the plurality of slide portions configured to line up in parallel with each other in a predetermined array direction to perform a linear movement in a slide direction between a first end side and a second end side, one or more base end holding portions installed, in an immobile manner at least in the slide direction, on the first end side that is a base end of the linear movement, each of the base end holding portions configured to hold, via the connector cup, one of a plurality of other-end side connectors that are provided on the other-end side among the plurality of connectors, a connector transfer mechanism configured to detach the one-end side connector and the other-end side connector together with the connector cups from the sub-harness mounting plate attached to the plate fixing portion, transfer the one-end side connector together with the connector cup to the slide portion, and transfer the other-end side connector together with the connector cup to the base end holding portion, and an electric wire processing portion configured to perform electric wire processing including processing to form the branch shape by selectively bundling electric wires of the plurality of sub-harnesses stretched, by the linear movement, between the plurality of slide portions and the one or more base end holding portions.

In order to solve the above problems, wire harness manufacturing method comprising, using the above-described wire harness manufacturing apparatus, a plate mounting step attaching, to the plate fixing portion, the sub-harness mounting plate on which the plurality of sub-harnesses are mounted while the connector cup is attached to the connector included in each of the sub-harnesses in a detachable manner, a connector transfer step in which the connector transfer mechanism detaches the one-end side connector and the other-end side connector together with the connector cups from the sub-harness mounting plate attached to the plate fixing portion, transfers the one-end side connector together with the connector cup to the slide portion, and transfers the other-end side connector together with the connector cup to the base end holding portion, and an electric wire processing step in which the electric wire processing portion performs electric wire processing including processing to form the branch shape by selectively bundling electric wires of the plurality of sub-harnesses stretched, by the linear movement, between the plurality of slide portions and the one or more base end holding portions.

### Advantageous Effects of the Invention

According to the wire harness manufacturing apparatus and the wire harness manufacturing method explained above, manufacturing tasks can be automatically performed while dealing with various types of harnesses.

### BRIEF DESCRIPTION OF THE DRAWINGS

FIG. 1 is an external perspective view illustrating a wire harness manufacturing apparatus according to one embodiment.

FIG. 2 is a schematic diagram illustrating an example of a wire harness manufactured by the wire harness manufacturing apparatus illustrated in FIG. 1.

FIG. 3 is a diagram illustrating a connector cup, a sub-harness mounting plate, and a plate fixing portion related to reception of a sub-harness in the wire harness manufacturing apparatus illustrated in FIG. 1, together with a slide portion and a base end holding portion which are a sub-harness transfer destination.

FIG. 4 illustrates an enlarged diagram of the connector cup, the sub-harness mounting plate, and the plate fixing portion illustrated in FIG. 3.

FIG. 5 is a plan view of the connector cup, the sub-harness mounting plate, and the plate fixing portion illustrated in FIG. 4, seen from the arrow V11 direction of FIG. 4.

FIG. 6 is an enlarged perspective view of the connector cups illustrated in FIGS. 3 to 5 together with the cup holding portions in the sub-harness mounting plate.

FIG. 7 is an enlarged perspective view of slide portions illustrated in FIGS. 1 and 3.

FIG. 8 is an enlarged perspective view of base end holding portions illustrated in FIGS. 1 and 3.

FIG. 9 is an oblique view of the connector transfer mechanism illustrated in FIG. 1, illustrating a holding mechanism for a front connector and a rear connector from an arrow V12 direction in FIG. 1.

FIG. 10 is an enlarged perspective view of the holding mechanism illustrated in FIG. 9.

FIG. 11 is an enlarged perspective view of the electric wire processing portion illustrated in FIG. 1.

FIG. 12 is a schematic flow chart illustrating a series of processing steps in the wire harness manufacturing method executed using the wire harness manufacturing apparatus illustrated in FIG. 1.

FIG. 13 is a schematic diagram illustrating step S21 and step S22 of tension control of the electric wire under the control of the control unit during execution of the wire harness manufacturing method illustrated in FIG. 12.

FIG. 14 is a schematic diagram illustrating steps S23 to S25 of tension control of the electric wire under the control of the control unit during execution of the wire harness manufacturing method illustrated in FIG. 12.

FIG. 15 is a schematic diagram illustrating step S26 and step S27 of tension control of the electric wire under the control of the control unit during execution of the wire harness manufacturing method illustrated in FIG. 12.

### DETAILED DESCRIPTION OF THE EXEMPLARY EMBODIMENT

Hereinafter, one embodiment of a wire harness manufacturing apparatus and a wire harness manufacturing method is explained.

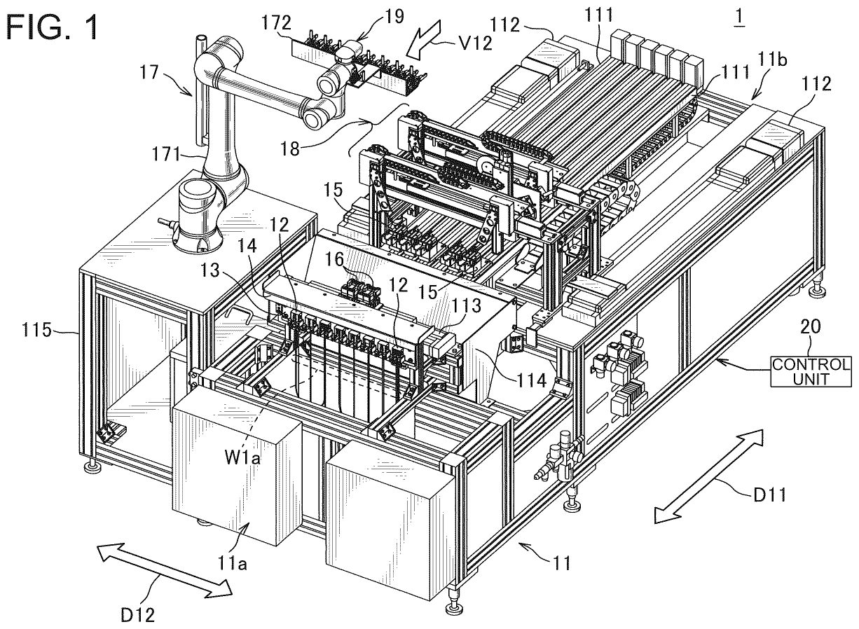

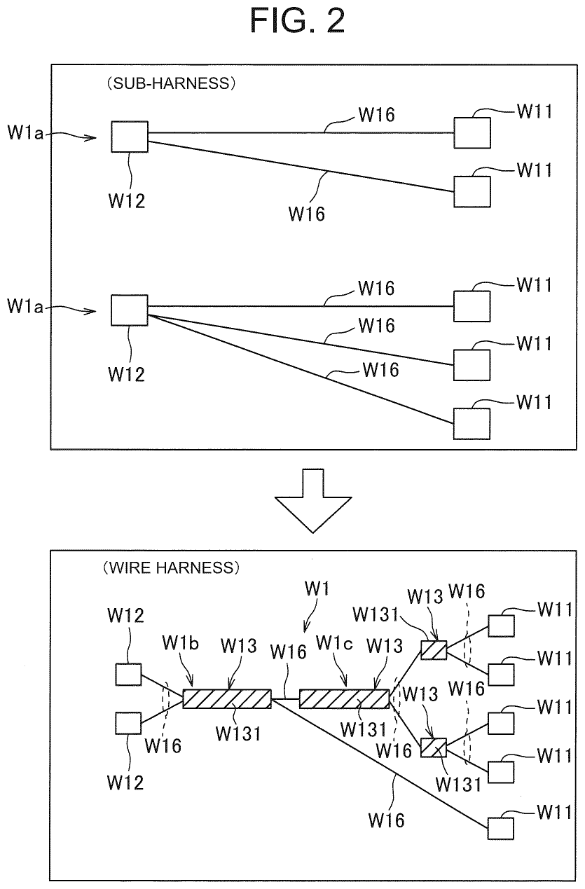

FIG. 1 is an external perspective view illustrating a wire harness manufacturing apparatus according to one embodiment. FIG. 2 is a schematic diagram illustrating an example of a wire harness manufactured by the wire harness manufacturing apparatus illustrated in FIG. 1.

The wire harness manufacturing apparatus 1 of the present embodiment is an apparatus for automatically manufacturing a branch shape wire harness W1 as illustrated in FIG. 2 as an example.

The wire harness W1 to be manufactured is a component that is mounted and routed in an automobile to connect multiple devices inside the automobile. The wire harness W1 includes multiple front connectors W11, multiple rear connectors W12, and multiple tape-wrapped portions W13.

The front connector W11 is a connector on one-end side that is held by a slide portion 15 described below of the wire harness manufacturing apparatus 1 to be moved in a slide direction D11. On the other hand, the rear connector W12 is the other-end side connector that is held by a base end holding portion 16 described below and is immobile in the slide direction D11. Here, in the present embodiment, the wire harness W1 to be manufactured is composed of one or more electric wires W16 and multiple sub-harnesses W1a in each of which both ends of the electric wire W16 are connected to the front connector W11 and the rear connector W12. This combination is accomplished by formation of the tape-wrapped portion W13.

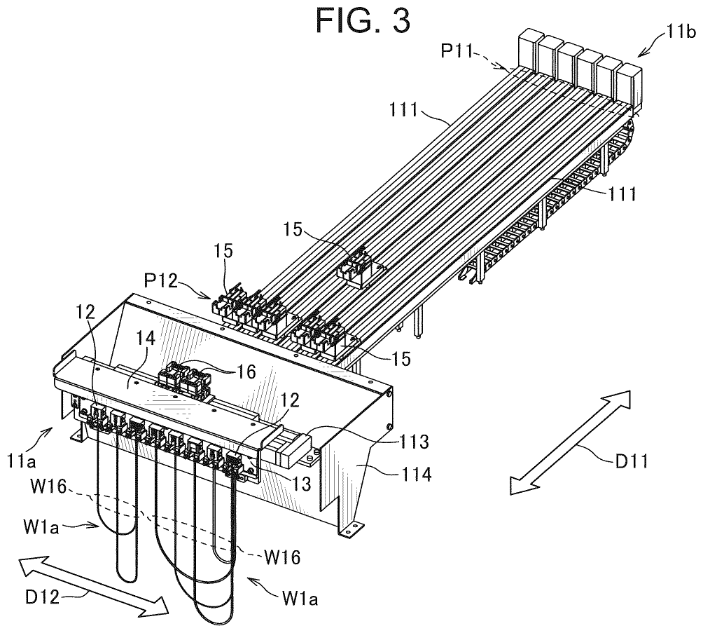

The tape-wrapped portion W13 is a portion where the electric wires W16 of the multiple sub-harnesses W1a are selectively bundled together and wrapped with a tape W131. In the example of FIG. 3, first, the tape-wrapped portion W13 is formed on a main line portion W1b in which the electric wires W16 of all the sub-harnesses W1a are bundled. The main line portion W1b on the side of the rear connector W12 branches into two, which are connected to the rear connectors W12. On the other hand, the main line portion W1b on the side of the front connector W11 is branched into two, one of which, an intermediate line portion W1c, is formed with a tape-wrapped portion W13, and the other of which extends directly and is connected to the front connector W11. The intermediate line portion W1c branches into two, and each branch line portion W1d further branches into two, the ends of which are connected to the front connectors W11. Between the intermediate line portion W1c and the front connectors W11, a tape W131 is wrapped around each branch point to form tape-wrapped portions W13.

The wire harness manufacturing apparatus 1 illustrated in FIG. 1 is an apparatus that automatically manufactures the wire harness W1 described above by receiving a supply of multiple sub-harnesses W1a as materials. The wire harness manufacturing apparatus 1 includes an apparatus frame 11, connector cups 12, a sub-harness mounting plate 13, a plate fixing portion 14, slide portions 15, base end holding portions 16, a connector transfer mechanism 17, an electric wire processing portion 18, a part number obtaining portion 19, and a control unit 20.

The apparatus frame 11 is a frame having a roughly rectangular block-like appearance. On the upper surface thereof, multiple slide rails 111 that guide each slide portion 15 in the slide direction D11 between the first end side 11a and the second end side 11b are installed so as to be aligned parallel to each other in an array direction D12 that intersects with the slide direction D11. In addition, a pair of electric wire processing rails 112 are installed on the upper surface of the apparatus frame 11 such that the multiple slide rails 111 are interposed between the pair of electric wire processing rails 112 in the array direction D12. The pair of electric wire processing rails 112 holds the electric wire processing portion 18 so that the electric wire processing portion 18 straddles over the multiple slide rails 111 from one side to the other, and the pair of electric wire processing rails 112 guides the electric wire processing portion 18 in the slide direction D11. In addition, a base end rail 113 is provided so as to extend in the array direction D12 with a gap between the ends of the first end sides 11a of the multiple slide rails 111. This base end rail 113 guides the base end holding portions 16 in the array direction D12. In addition, a delivery location 114 for the manufactured wire harness W1 is provided between the ends of the first end sides 11a of the slide rails 111, which is the movement end portion of the slide portion 15, and the base end rail 113, which is the installation position of the base end holding portions 16. A plate fixing portion 14 is provided on the first end side 11a, with a base end rail 113 being interposed between the delivery location 114 and the plate fixing portion 14, and the sub-harness W1a is supplied to the wire harness manufacturing apparatus 1 by attaching a sub-harness mounting plate 13 to the plate fixing portion 14. This sub-harness W1a is transferred so that it is stretched between the slide portion 15 and the base end holding portion 16, and the wire harness W1 to be manufactured is manufactured by moving the slide portion 15 and performing electric wire processing in the electric wire processing portion 18.

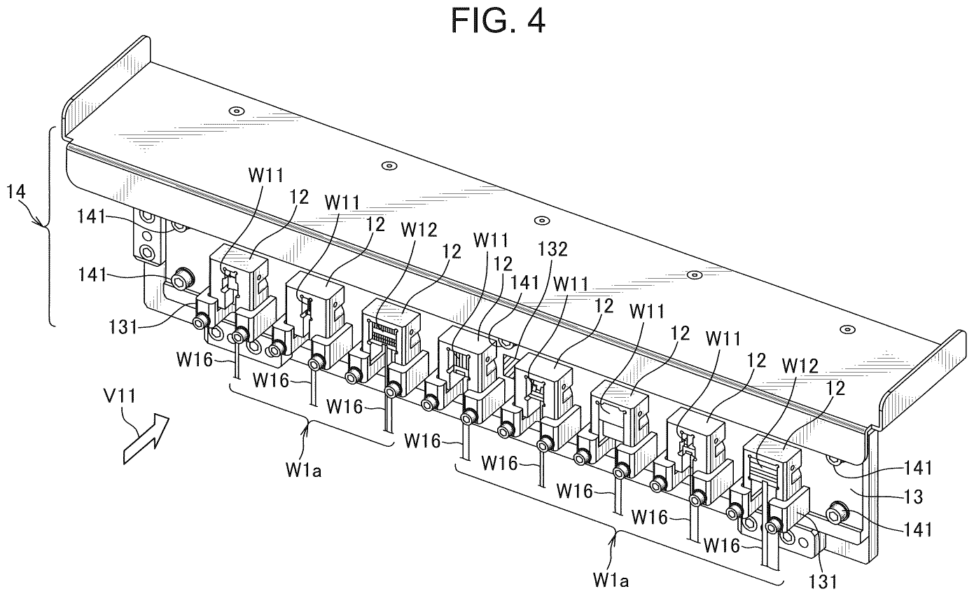

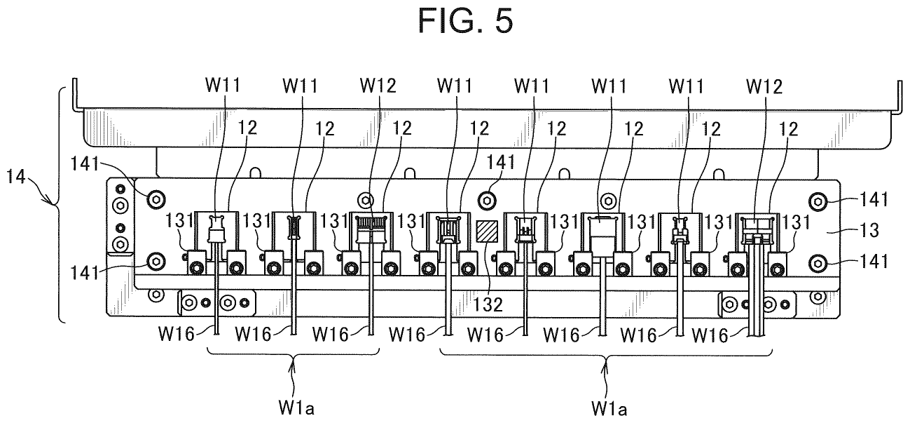

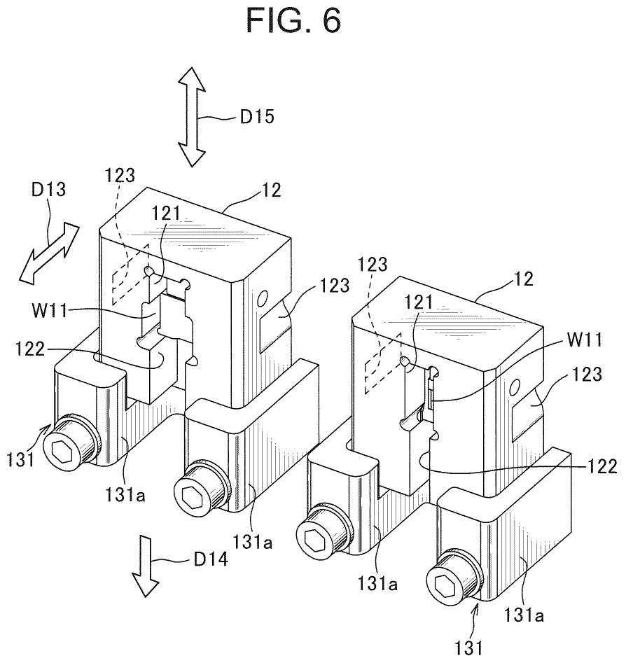

FIG. 3 is a diagram illustrating a connector cup, a sub-harness mounting plate, and a plate fixing portion related to reception of a sub-harness in the wire harness manufacturing apparatus illustrated in FIG. 1, together with a slide portion and a base end holding portion which are a sub-harness transfer destination. FIG. 4 illustrates an enlarged diagram of the connector cup, the sub-harness mounting plate, and the plate fixing portion illustrated in FIG. 3. FIG. 5 is a plan view of the connector cup, the sub-harness mounting plate, and the plate fixing portion illustrated in FIG. 4, seen from the arrow V11 direction of FIG. 4. FIG. 6 is an enlarged perspective view of the connector cups illustrated in FIGS. 3 to 5 together with the cup holding portions in the sub-harness mounting plate. In FIG. 6, two connector cups 12 are representatively illustrated together with two cup holding portions 131.

Multiple connector cups 12 are provided to attachably/detachably accommodate the front connector W11 and the rear connector W12 of each sub-harness W1a, which will be the material of the wire harness W1 to be manufactured. Of these multiple connector cups 12, accommodation chambers 121 for the front connector W11 and the rear connector W12 are formed in a rectangular recess shape that corresponds to the shape of the connector to be accommodated, but the outer shape is formed to be a common rectangular block shape. The accommodation chamber 121 can accommodate one connector each from the opening on the front side in the figure in an accommodation chamber depth direction D13. A passage groove 122 for the electric wire W16 is formed extending from the accommodation chamber 121 toward one of the four side surfaces of the connector cup 12 (the lower side surface in the figure). The electric wire W16 connected to the accommodated connector is configured to extend through this passage groove 122 to the outside of the connector cup 12 in an electric wire extension direction D14. The connector cups 12 are held one by one in the cup holding portion 131 provided on the sub-harness mounting plate 13 so as to be attachably/detachably attached in a cup attachment/detachment direction D15 along the electric wire extension direction D14. While the connector cup 12 is attached to the front connector W11 and the rear connector W12 of the sub-harness W1a, the connector cup 12 is carried together with the sub-harness W1a by the connector transfer mechanism 17. A pair of side surfaces of the connector cup 12 along the cup attachment/detachment direction D15 are provided with transfer locking grooves 123 that is locked by the connector transfer mechanism 17 when the sub-harness W1a is transferred.

The sub-harness mounting plate 13 is a rectangular plate-shaped member to which the multiple sub-harnesses W1a are mounted with the connector cups 12 attached in an attachable/detachable manner to the front connector W11 and the rear connector W12 included in each sub-harness W1a. The sub-harness mounting plate 13 has the above-described cup holding portions 131 arranged in a line in the longitudinal direction. Each cup holding portion 131 holds one connector cup 12 accommodating the front connector W11 and the rear connector W12. The cup holding portion 131 embracing and holding, with a pair of cup holding arms 131a, the end of the electric wire W16 on the electric wire extension side where the passage groove 122 for the electric wire W16 is open in the connector cup 12. The electric wire W16 extending from the connector cup 12 through the passage groove 122 passes between the pair of cup holding arms 131a to extend in the electric wire extension direction D14.

Then, as described above, the sub-harness W1a is supplied to the wire harness manufacturing apparatus 1 by attaching the sub-harness mounting plate 13 to the plate fixing portion 14. At this time, the sub-harness mounting plate 13 is attached to the plate fixing portion 14 in a state in which multiple sub-harnesses W1a, which will be the material of the wire harness W1 to be manufactured, are mounted by connector retention via the connector cups 12 and the cup holding portion 131. In addition, the sub-harness mounting plate 13 is attached to the plate fixing portion 14 in an attachable/detachable manner by fastening with multiple screws 141.

In the present embodiment, the mounting of the multiple sub-harnesses W1a to the sub-harness mounting plate 13 is performed at a work location away from the apparatus frame 11. The multiple sub-harnesses W1a are supplied as a set with this sub-harness mounting plate 13. The wire harness W1 to be manufactured from the multiple sub-harnesses W1a supplied in this manner is affixed with a part number that identifies the wire harness W1. A code image 132 is depicted on the sub-harness mounting plate 13, which indicates the part number of the wire harness W1 manufactured from the multiple sub-harnesses W1a to be mounted. Examples of this code image 132 include a bar code and a QR code (registered trademark). In the wire harness manufacturing apparatus 1, the part number is obtained via the code image 132 of the sub-harness mounting plate 13 attached to the plate fixing portion 14, and various processing according to the part number is performed.

Next, the slide portions 15 and the base end holding portions 16 illustrated in FIGS. 1 and 3 is described. The multiple sub-harnesses W1a supplied as described above are transferred so as to be stretched between the slide portions 15 and the base end holding portions 16.

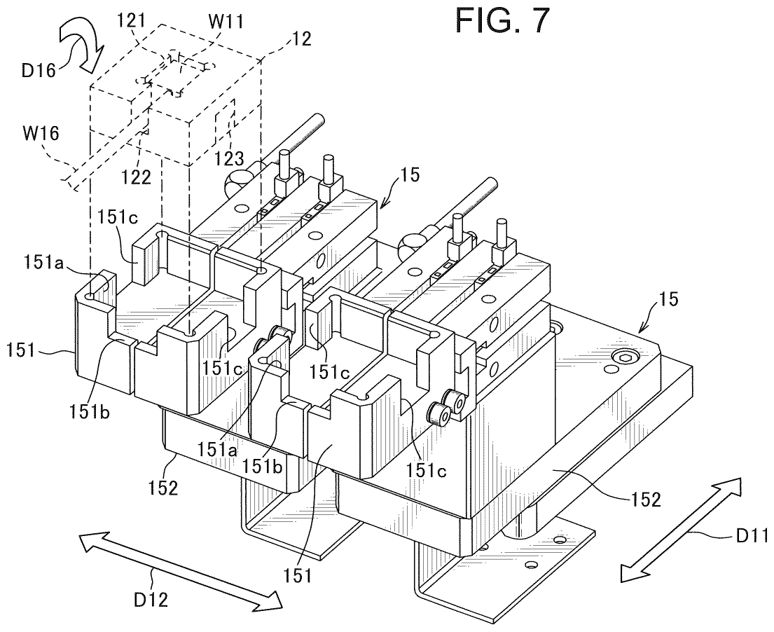

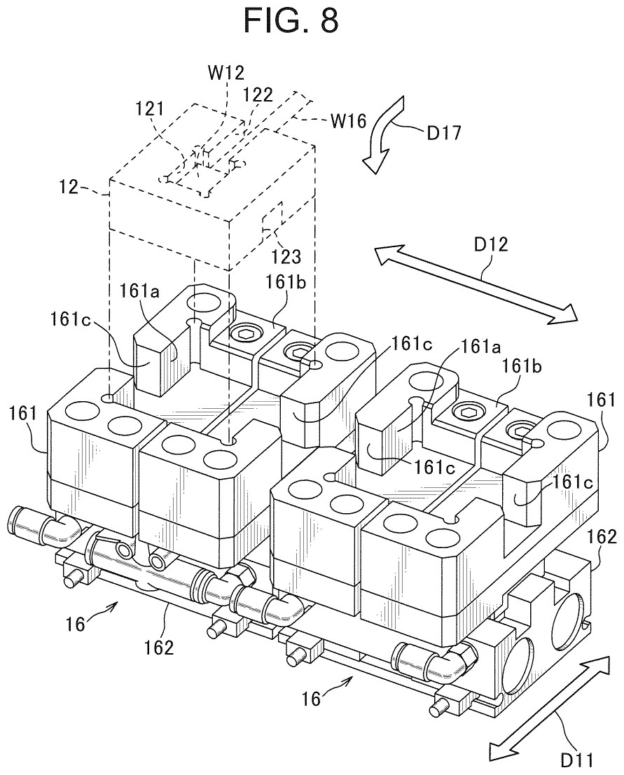

FIG. 7 is an enlarged perspective view of slide portions illustrated in FIGS. 1 and 3. FIG. 8 is an enlarged perspective view of base end holding portions illustrated in FIGS. 1 and 3. FIG. 7 illustrates two representative slide portions 15. FIG. 8 illustrates all of the base end holding portions 16.

The slide portion 15 is a portion that holds the front connectors W11, among the front connectors W11 and the rear connectors W12 of the sub-harness W1a, via the connector cup 12. Multiple slide portions 15 are provided so as to move linearly in the slide direction D11 between the first end side 11a and the second end side 11b of the apparatus frame 11, the slide portions 15 being arranged parallel to each other in the array direction D12 that intersects the slide direction D11. These multiple slide portions 15 are slidably held in a one-to-one correspondence by multiple slide rails 111 on the upper surface of the apparatus frame 11. Each slide portion 15 includes a slide side cup holding portion 151 that holds the connector cup 12 in an attachable/detachable manner, and a slide connection portion 152 that supports the slide side cup holding portion 151 and slidably connects to the slide rail 111. The slide side cup holding portion 151 is provided with a cup receiving recess 151a in a rectangular recessed shape that opens upward. The connector cup 12 of the front connector W11 is placed into the cup receiving recess 151a from above with the accommodation chamber 121 of the front connector W11 facing upward and the passage groove 122 of the electric wire W16 opening toward the first end side 11a. As a result, the connector cup 12 is moved from the holding orientation on the sub-harness mounting plate 13 to a slide side rotation mounting direction D16 in which the connector cup 12 is tilted 90° toward the rear side and placed into the cup receiving recess 151a. An electric wire passage hole 151b through which the electric wire W16 passes to the first end side 11a is formed in the peripheral wall of the cup receiving recess 151a on the first end side 11a. In addition, a pair of side walls along the slide direction D12 are formed with notches 151c to avoid the locking portion of the connector transfer mechanism 17 locked in the transfer locking grooves 123 when the connector cup 12 is inserted.

The base end holding portion 16 is a part that holds the rear connectors W12, among the front connectors W11 and the rear connectors W12 of the sub-harness W1a, via the connector cup 12. The base end holding portions 16 are arrayed in a line in the array direction D12, and one or more base end holding portions 16 are provided on the first end side 11a, which is the base end of the linear movement of the slide portion 15, so that they are immobile in the slide direction D11 but can move linearly in the array direction D12. The one or more base end holding portions 16 are slidably held on one base end rail 113 extending in the array direction D12 on the upper surface of the apparatus frame 11. Each base end holding portion 16 includes a base end cup holding portion 161 that holds the connector cup 12 in an attachable/detachable manner, and a base end connecting portion 162 that supports the base end cup holding portion 161 and slidably connects to the base end rail 113. The base end cup holding portion 161 is provided with a cup receiving recess 161a in a rectangular recessed shape that opens upward. The connector cup 12 of the rear connector W12 is placed into the cup receiving recess 161a from above with the accommodation chamber 121 of the rear connector W12 facing upward and the passage groove 122 of the electric wire W16 opening toward the second end side 11b. As a result, the connector cup 12 is moved from the holding orientation on the sub-harness mounting plate 13 to a base end rotation mounting direction D17 in which the connector cup 12 is tilted 90° toward the rear side and placed into the cup receiving recess 161a. In the base end holding portion 16, the electric wire W16 is extended to the second end side 11b in the opposite direction to the slide portion 15 described above. Therefore, the base end rotation mounting direction D17 is a rotation direction in which the direction of the extension of the electric wire W16 is 180° different direction from the slide side rotation mounting direction D16. An electric wire passage hole 161b through which the electric wire W16 passes to the second end side 11b is formed in the peripheral wall of the cup receiving recess 161a on the second end side 11b. In addition, a pair of side walls along the slide direction D11 are formed with notches 161c to avoid the locking portion of the connector transfer mechanism 17 locked in the transfer locking grooves 123 when the connector cup 12 is inserted.

The connector transfer mechanism 17 is the part that transfers the front connector W11 and the rear connector W12 from the sub-harness mounting plate 13 attached to the plate fixing portion 14 to the slide portion 15 and the base end holding portion 16. The sub-harness W1a is transferred between the slide portion 15 and the base end holding portion 16 by a connector transfer operation by the connector transfer mechanism 17.

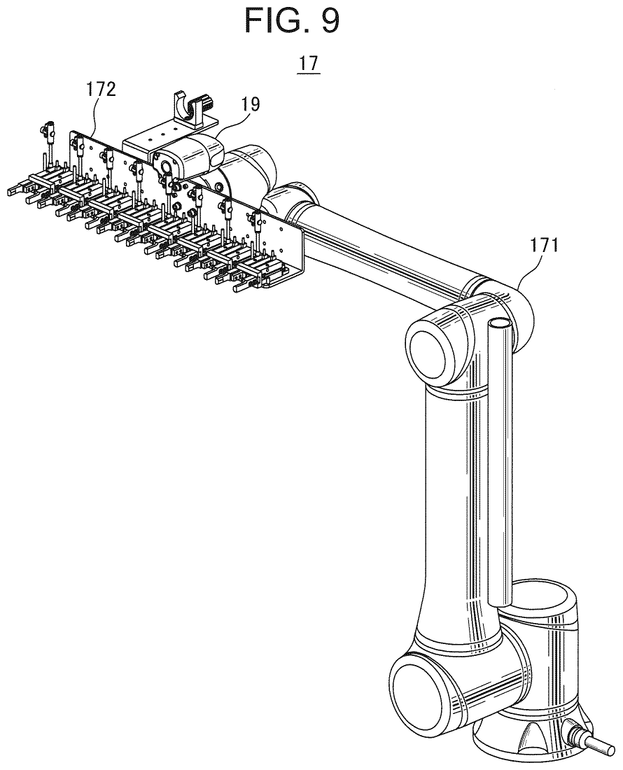

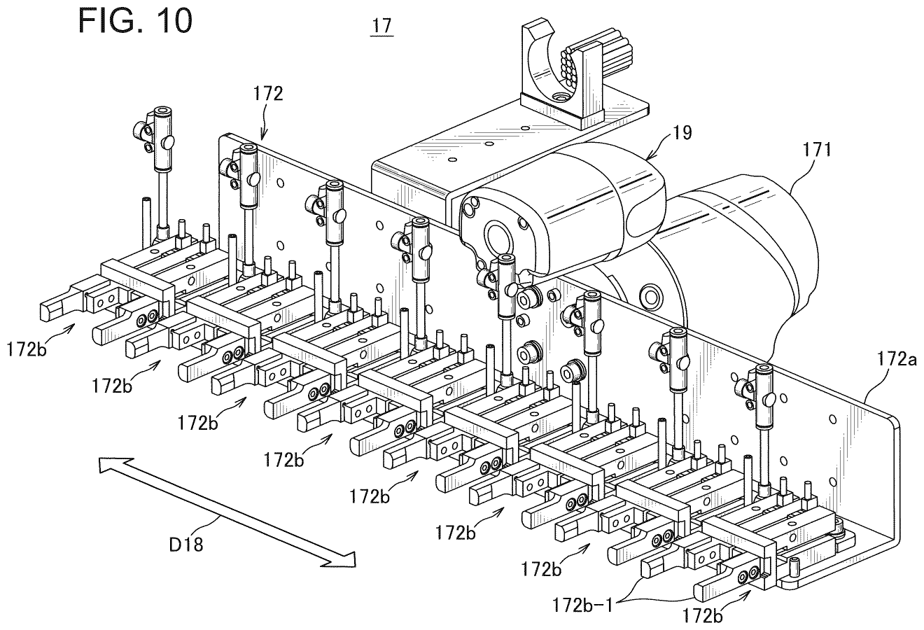

FIG. 9 is an oblique view of the connector transfer mechanism illustrated in FIG. 1, illustrating a holding mechanism for a front connector and a rear connector from an arrow V12 direction in FIG. 1. FIG. 10 is an enlarged perspective view of the holding mechanism illustrated in FIG. 9.

In the connector transfer operation, the connector transfer mechanism 17 first detaches the front connector W11 and the rear connector W12 together with the connector cups 12 from the sub-harness mounting plate 13. Then, the connector transfer mechanism 17 transfers the front connector W11 together with the connector cup 12 to the slide portion 15, and transfers the rear connector W12 together with the connector cup 12 to the base end holding portion 16. This connector transfer mechanism 17 includes a robot arm 171 and a holding mechanism 172. The robot arm 171 is an articulated robot mounted on the upper surface of a mechanism base 115 provided adjacent to the base end rail 113 in the array direction D12 in the apparatus frame 11, as illustrated in FIG. 1. The holding mechanism 172 is attached to the tip of the robot arm 171 and is a mechanism that holds and detaches the front connector W11 and the rear connector W12 in one-to-one manner together with the multiple connector cups 12 attached to the sub-harness mounting plate 13. The holding mechanism 172 has an L-shaped angle 172a connected to the tip of the robot arm 171, and a vertical wall portion of this L-shaped angle 172a is connected to the tip of the robot arm 171. The holding mechanism 172 has arm mechanisms 172b fixed to a bottom wall portion of the L-shaped angle 172a, and each of the arm mechanisms 172b holds the connector cup 12 with the pair of holding arms 172b-1. Multiple arm mechanisms 172b are fixed to a bottom wall portion of the L-shaped angle 172a in a line in a longitudinal direction D18 thereof so as to be able to hold, in one-to-one manner, multiple connector cups 12, which are attached to the sub-harness mounting plate 13 in a connector-accommodated state. In addition, the array spacing of these multiple arm mechanisms 172b corresponds to the array spacing of the slide portions 15 in the array direction D12, i.e., the array spacing of the multiple slide rails 111, so as to enable a connector transfer operation to the slide portions 15. In order to enable one-to-one confrontation with multiple arm mechanisms 172b arranged with such spacing, the array spacing of the cup holding portions 131 that hold the connector cups 12 on the sub-harness mounting plate 13 also corresponds to the array spacing of the slide rails 111.

In the connector transfer mechanism 17, the robot arm 171 moves the holding mechanism 172 so that multiple connector cups 12 in the connector-accommodated state on the sub-harness mounting plate 13 face multiple arm mechanisms 172b in one-to-one manner. Each arm mechanism 172b holds each connector cup 12 in the opposing position so that the tip of the holding arm 172b-1 is engaged with the transfer locking groove 123 of the connector cup 12. Next, the robot arm 171 carries the holding mechanism 172 holding the connector cups 12 to the slide portions 15 and the base end holding portions 16. In the slide portion 15, the connector cup 12 of the front connector W11 is placed into the slide side cup holding portion 151 and then released, thereby transferring the front connector W11. In addition, in the base end holding portion 16, the connector cup 12 of the rear connector W12 is placed in the base end cup holding portion 161 and then released, thereby transferring the rear connector W12.

When multiple sub-harnesses W1a are transferred between the slide portions 15 and the base end holding portions 16 by this operation of the connector transfer mechanism 17, the slide portions 15 move linearly to positions corresponding to the branch shape of the wire harness W1 being manufactured. For the electric wire W16 of the sub-harness W1a stretched between the slide portion 15 and the base end holding portion 16 by the linear movement of the slide portion 15, the electric wire processing portion 18 performs electric wire processing, including processing to selectively bundle the electric wires W16 to form a branch shape. In the present embodiment, the electric wire processing involves selective bundling of the electric wires W16 and wrapping of tapes at various locations.

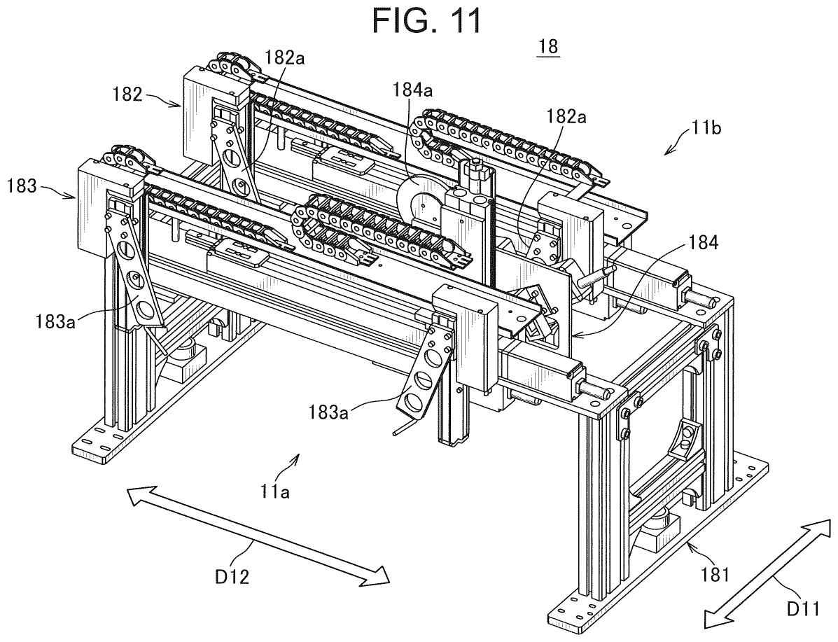

FIG. 11 is an enlarged perspective view of the electric wire processing portion illustrated in FIG. 1.

The electric wire processing portion 18 is a portion that performs bundling and tape wrapping on the electric wires W16 of multiple sub-harnesses W1a, and includes a mechanism frame 181, a front bundle mechanism 182, a rear bundle mechanism 183, and a tape wrapping mechanism 184. The mechanism frame 181 is a frame portion held by a pair of electric wire processing rails 112 on the upper surface of the apparatus frame 11 so as to be able to move straight ahead in the slide direction D11 while straddling above multiple slide rails 111 in the array direction D12. The front bundle mechanism 182 is a mechanism portion that is installed on the second end side 11b of the apparatus frame 11 in the mechanism frame 181 and selectively bundles the electric wires W16 with a pair of bundle arms 182a that are movable in the array direction D12. The rear bundle mechanism 183 is a mechanism portion that is installed on the first end side 11a of the apparatus frame 11 in the mechanism frame 181 and selectively bundles the electric wires W16 with a pair of bundle arms 183a that are movable in the array direction D12. The tape wrapping mechanism 184 is a mechanism portion installed in a position of the mechanism frame 181 between the front bundle mechanism 182 and the rear bundle mechanism 183 in the slide direction D11. This tape wrapping mechanism 184 wraps a tape while rotating a tape reel 184a around the axis of the electric wires W16 bundled at the front and rear in the slide direction D11 by the front bundle mechanism 182 and rear bundle mechanism 183.

In the present embodiment, the formation of the branch shape by the connector transfer operation with the connector transfer mechanism 17, the linear movement of the slide portion 15, and the electric wire processing with the electric wire processing portion 18 described above is performed under the control of the control unit 20 based on the part number of the wire harness W1 to be manufactured. For this control, the wire harness manufacturing apparatus 1 of the present embodiment is provided with a part number obtaining portion 19 that obtains the part number of the wire harness W1 to be manufactured.

As explained with reference to FIGS. 4 and 5, the sub-harness mounting plate 13 has a code image 132 depicted thereon illustrating the part number of the wire harness W1 manufactured from the multiple sub-harnesses W1a to be mounted. The part number obtaining portion 19 is a code reader that obtains the part number by reading this code image 132. The reading occurs when the holding mechanism 172 of the connector transfer mechanism 17 faces the sub-harness mounting plate 13 in order to detach the front connector W11 and the rear connector W12. To enable reading at this timing, the code reader serving as the part number obtaining portion 19 is attached to the upper edge of the vertical wall portion of the L-shaped angle 172a of the holding mechanism 172 of the connector transfer mechanism 17, as illustrated in FIG. 10. The part number obtained by the part number obtaining portion 19 from the code image 132 is transmitted from the part number obtaining portion 19 to the control unit 20. In control unit 20, multiple part numbers and the operation contents of each mechanism portion for forming the branch shape of the wire harness to which each part number is affixed are registered in advance in correspondence with each other. Then, when the part number obtaining portion 19 transmits the part number of the wire harness W1 to be manufactured this time, the control unit 20 operates each mechanism portion in accordance with the operation contents associated with that part number.

First, the connector transfer mechanism 17 transfers the front connector W11, which has been detached from the sub-harness mounting plate 13 together with the connector cup 12, to the slide portion 15, which is associated in one-to-one manner via the part number. At this time, in the present embodiment, the slide portions 15 are provided in a number equal to or greater than the number of the front connectors W11 anticipated in advance for the wire harness W1 to be manufactured. Before transfer by the connector transfer mechanism 17, all the slide portions 15 wait in an initial position P11 on the second end side 11b illustrated in FIG. 3. During transfer by the connector transfer mechanism 17, only the slide portion 15 that is associated as the transfer destination of the front connector W11 via the part number moves so as to line up in a line in the array direction D12 from the initial position P11 to a slide side attachment/detachment position P12 of the first end side 11a. If there is a non-transferable slide portion 15 that is not associated with a part number, the slide portion 15 remains in the initial position P11 so as not to interfere with subsequent tasks.

In addition, the connector transfer mechanism 17 transfers the rear connector W12, which has been detached from the sub-harness mounting plate 13 together with the connector cup 12, to the base end holding portion 16, which is associated in one-to-one manner via the part number. In the present embodiment, similar to the slide portions 15, the base end holding portions 16 are provided in a number equal to or greater than the number of the rear connectors W12 anticipated in advance for the wire harness W1 to be manufactured. However, regardless of whether the base end holding portions 16 are associated with part numbers, all of the base end holding portions 16 are positioned in an array direction D12 to positions corresponding to the processing operations based on the part numbers of the connector transfer mechanism 17 and the electric wire processing portion 18. Since the base end holding portions 16 are lined up in a line in the array direction D12 on the base end rail 113, if there is a base end holding portion 16 that is not moving and is in a waiting state, it will hinder the movement of the other base end holding portions 16. In the present embodiment, by positioning all base end holding portions 16 regardless of whether they are associated with part numbers, the presence of non-transferable base end holding portions 16 does not hinder the movement of other base end holding portions 16.

After the slide portion 15 receives the transferred front connector W11 in the connector transfer operation by the connector transfer mechanism 17, the slide portion 15 moves from the slide side attachment/detachment position P12 in the slide direction D11 to a position corresponding to the branch shape of the wire harness W1 identified by the part number. Furthermore, the electric wire processing portion 18 moves in the slide direction D11 on the electric wire processing rail 112 according to the branch shape of the wire harness W1 identified by the part number, and operates the front bundle mechanism 182, the rear bundle mechanism 183, and the tape wrapping mechanism 184. During operation of the electric wire processing portion 18, the slide portions 15 and the base end holding portions 16 are controlled to make small movements so as to avoid placing excessive stress on the electric wires W16 processed in the electric wire processing. For example, during connector transfer, the base end holding portion 16 is positioned in a base end attachment/detachment position that faces, in one-to-one manner, the array of the rear connectors W12 on the holding mechanism 172 of the connector transfer mechanism 17. On the other hand, when the electric wires W16 are bundled by the front bundle mechanism 182 or the rear bundle mechanism 183, the base end holding portion 16 is controlled to move from the base end attachment/detachment position described above to close the spacing toward the bundle side of the electric wires W16 in the array direction D12 so as to prevent load from being applied to the electric wires W16. In addition, the slide portions 15 move from the slide side attachment/detachment position P12 to the second end side 11b during connector transfer to apply appropriate tension to the electric wires W16, and then moves back slightly to the first end side 11a to relieve the tension in the electric wires W16 when the electric wires W16 are pulled by the bundle.

After the electric wire processing at the electric wire processing portion 18 and the branch formation, the manufactured wire harness W1 is delivered as follows. First, the slide portion 15, which holds the front connector W11 of the manufactured wire harness W1 via the connector cup 12, moves to the slide side attachment/detachment position P12, similar to the connector transfer operation. In addition, the base end holding portion 16, which holds the rear connector W12 via the connector cup 12, moves to a position where it can face the arm mechanism 172b in the holding mechanism 172 of the connector transfer mechanism 17, similar to the connector transfer operation. Thereafter, the holding mechanism 172 of the connector transfer mechanism 17 detaches the front connector W11 together with the connector cup 12 from the slide portion 15 of the slide side attachment/detachment position P12, and detaches the rear connector W12 together with the connector cup 12 from the base end holding portion 16.

As described above, in the apparatus frame 11, a delivery location 114 for the manufactured wire harness W1 is provided between the base end rail 113 that holds the base end holding portions 16 and the first end side 11a of the multiple slide rails 111. This delivery location 114 is in the shape of a rectangular recessed pocket that opens upward and has a sloped inner surface on the side of the slide rail 111. After detaching the front connector W11 and the rear connector W12 of the manufactured wire harness W1 as described above, the connector transfer mechanism 17 transports the manufactured wire harness W1 to an upper position facing the sloped inner surface at the delivery location 114 through an opening. Then, the front connector W11 and the rear connector W12 are released at an upper position of the delivery location 114 to deliver the manufactured wire harness W1. The manufactured wire harness W1 is dropped onto the sloping inner surface of the delivery location 114 and slides down the inner surface to the bottom where it is placed.

Next, the wire harness manufacturing method executed using the wire harness manufacturing apparatus illustrated in FIG. 1 is explained again, although some of the explanation overlaps with the explanation so far.

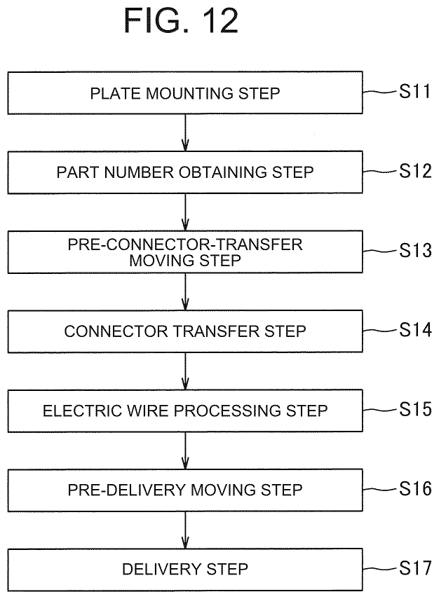

FIG. 12 is a schematic flow chart illustrating a series of processing steps in the wire harness manufacturing method executed using the wire harness manufacturing apparatus 1 illustrated in FIG. 1.

The processing illustrated in FIG. 12 starts when a sub-harness mounting plate 13 is prepared on which multiple sub-harnesses W1a, which will be the material of the wire harness W1 to be manufactured, are mounted. As described above, the front connector W11 and the rear connector W12 included in each sub-harness W1a are mounted on a sub-harness mounting plate 13 with the connector cup 12 attached in an attachable/detachable manner.

When processing starts, the plate mounting step S11, in which the prepared sub-harness mounting plate 13 is attached to the plate fixing portion 14, is performed manually by the worker. After the installation is completed, a command to start manufacturing the harness is given to the wire harness manufacturing apparatus 1 via a predetermined operation, and the following processing is executed.

First, the robot arm 171 of the connector transfer mechanism 17 carries the part number obtaining portion 19 to a position facing the code image 132 of the sub-harness mounting plate 13, and then the part number obtaining portion 19 reads the code image 132 to obtain the part number (part number obtaining step S12). Subsequent processing is performed under the control of the control unit 20 based on the part number.

Following the part number obtaining step S12, a pre-connector-transfer moving step S13 is performed in which slide portion 15 is moved to slide side attachment/detachment position P12 and the base end holding portion 16 is moved to the base end attachment/detachment position. In this pre-connector-transfer moving step S13, which of the multiple slide portions 15 is to be moved from the initial position P11 to the slide side attachment/detachment position P12 is controlled based on the part number. Also, for the base end holding portions 16, the base end attachment/detachment position itself, that is, which arm mechanism 172b in the holding mechanism 172 of the connector transfer mechanism 17 each base end holding portion 16 faces in one-to-one manner, is controlled based on the part number.

Once the movement of slide portion 15 and base end holding portion 16 is completed, a connector transfer step S14 is executed in which the connector transfer mechanism 17 transfers the front connector W11 and the rear connector W12 to the slide portion 15 and the base end holding portion 16 of the movement destination. In this connector transfer step S14, the front connector W11 and the rear connector W12 are detached together with the connector cup 12 from the sub-harness mounting plate 13, and transferred together with the connector cup 12 to the slide portion 15 and the base end holding portion 16. In this connector transfer step S14, which slide portion 15 each front connector W11 is transferred to and which base end holding portion 16 each rear connector W12 is transferred to are controlled based on the part number.

After connector transfer step S14, the slide portion 15 moves in the slide direction D11 to stretch the electric wires W16 between the slide portion 15 and the base end holding portion 16, and the electric wire processing step S15 is executed in which the electric wire processing portion 18 operates on the electric wire W16. In this electric wire processing step S15, the movement of the slide portion 15 and the operation content of the electric wire processing portion 18 are controlled based on the part number. Also, depending on the operation content of the electric wire processing portion 18, the position of the base end holding portion 16, for example, moving to the bundle side of the electric wire W16, is also controlled based on the part number.

Once the branch shape has been formed through the electric wire processing step S15 and the wire harness W1 to be manufactured is completed, a pre-delivery moving step S16 is executed in which the slide portion 15 and the base end holding portion 16 are moved in preparation for delivery of the manufactured wire harness W1. In this pre-delivery moving step S16, the slide portion 15 and the base end holding portion 16 move to the slide side attachment/detachment position P12 and the base end attachment/detachment position P13 based on the part number, similar to pre-connector-transfer moving step S13.

Finally, a delivery step S17 is performed in which the manufactured wire harness W1 is delivered to the delivery location 114 by the connector transfer mechanism 17. In this delivery step S17, the front connector W11 and the rear connector W12 are detached together with the connector cup 12 from the slide portion 15 and the base end holding portion 16 in the slide side attachment/detachment position P12 and the base end attachment/detachment position. The order of detachment at this time is controlled based on the part number. The manufactured wire harness W1 is taken out by detaching this connector. Thereafter, the connector transfer mechanism 17 carries the manufactured wire harness W1 to an upper position above the delivery location 114, and releases the front connector W11 and the rear connector W12 at this upper position, thereby delivering the manufactured wire harness W1 to the delivery location 114. With this delivery step S17, a series of processing steps in the wire harness manufacturing method according to the present embodiment is completed.

Here, in the present embodiment, after the slide portion 15 moves in step S15, each slide portion 15 applies tension to the electric wire W16 by pulling it toward the second end side 11b. In the wire harness manufacturing apparatus 1, the tension thus applied is controlled by the control unit 20 as follows during the execution of the wire harness manufacturing method.

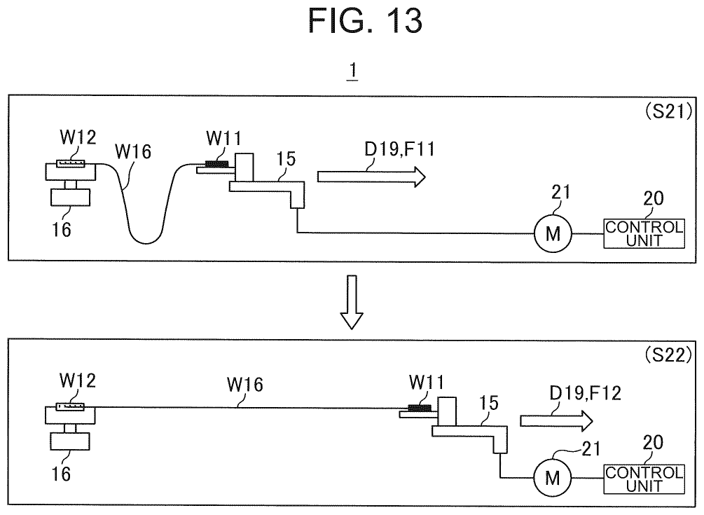

FIG. 13 is a schematic diagram illustrating step S21 and step S22 of tension control of the electric wire under the control of the control unit during execution of the wire harness manufacturing method illustrated in FIG. 12.

FIG. 13 illustrates a schematic diagram of the tension control processing of the control unit 20, which controls the tension applied to the electric wire W16 by the slide portion 15 in the wire harness manufacturing apparatus 1 during execution of the wire harness manufacturing method. The control unit 20 of the wire harness manufacturing apparatus 1 controls the movement of the slide portion 15, which moves linearly by driving a servo motor 21. The slide portion 15 holds the end of the electric wire W16 extending from the rear connector W12 of the base end holding portion 16 via the front connector W11, and moves linearly to pull the electric wire W16 to the second end side 11b. The control unit 20 controls the linear movement of the slide portion 15 and also controls the tension of the electric wire W16 as follows. That is, the control unit 20 obtains the driving force of the servo motor 21 as an index indicating the tension of the electric wire W16, compares the driving force as an index with a predetermined reference value when the slide portion 15 is at a stop, and controls the tension of the electric wire W16 by moving the slide portion 15 according to the comparison result.

Step S21 illustrated in FIG. 13 corresponds to the pulling of the electric wire W16 by the linear movement of the slide portion 15 in step S15 in FIG. 12. In this step S21, the servo motor 21 drives the slide portion 15 to move in the pulling direction D19, thereby pulling the electric wire W16. At this time, under the control of the control unit 20, the servo motor 21 drives the slide portion 15 with the following driving force F11. This driving force F11 is the force required for the slide portion 15 to pull and extend the electric wire W16, which has become loose between the slide portion 15 and the base end holding portion 16. In addition, when pulling the electric wire W16, the control unit 20 controls the amount of linear movement of the slide portion 15. This amount of movement is obtained in the control unit 20 based on the number of rotations of the servo motor 21 and the like. The control unit 20 stops multiple slide portions 15 when the multiple slide portions 15 have moved an amount corresponding to the branch shape of the part number.

In step S22, the tension of electric wire W16 ends, and slide portion 15 stops. In this stopped state, the slide portion 15 pulls the electric wire W16 in the pulling direction D19 with a balancing force F12 that balances the holding force of the electric wire end portion by the rear connector W12 held by the base end holding portion 16. This pulling by the balancing force F12 by the slide portion 15 imparts a predetermined tension to the electric wire W16. In the present embodiment, a value corresponding to the holding force at the base end holding portion 16 is used as a reference value.

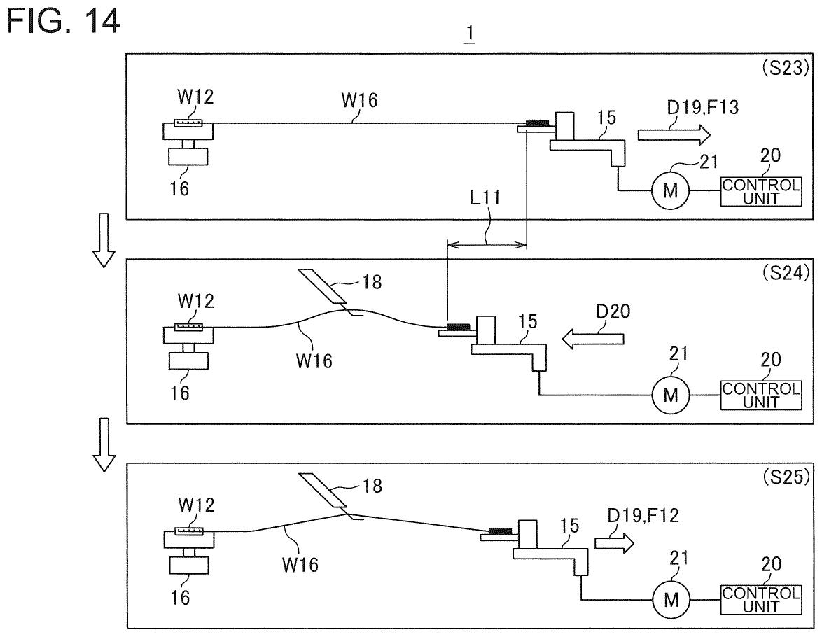

FIG. 14 is a schematic diagram illustrating steps S23 to S25 of tension control of the electric wire under the control of the control unit during execution of the wire harness manufacturing method illustrated in FIG. 12.

FIG. 14 illustrates an example of a situation in which the tension of electric wire W16 increases when the slide portion 15 is at a stop in the control unit 20 of the wire harness manufacturing apparatus 1, where the electric wire W16 is pulled by being bundled by the electric wire processing portion 18.

In step S23, the electric wire W16 from the rear connector W12 of the base end holding portion 16 is pulled by the slide portion 15 with a balancing force F12 against the holding force at the base end holding portion 16, and the electric wire processing portion 18 begins bundling the electric wire W16.

When the electric wire W16 is bundled by the electric wire processing portion 18, the electric wire W16 is pulled and the tension temporarily increases, and in response, the output of the servo motor 21 that drives the slide portion 15 temporarily increases from the balancing force F12 to an upward driving force F13. In the present embodiment, in the control unit 20, the reference value used for tension control is set to a value smaller than the driving force of the servo motor 21 that temporarily increases due to bundling of the electric wire W16 by the electric wire processing portion 18. When the rising driving force F13 of the pulling direction D19 eventually exceeds the reference value, processing in the control unit 20 proceeds to the next step S24.

In step S24, the control unit 20 moves the slide portion 15 in a tension relaxation direction D20, which is the opposite direction to the pulling direction D19 of the electric wire W16, by a relaxation distance L11 that is longer than the distance required for the driving force of the servo motor 21 to fall below the reference value. As a result, the electric wire W16 from the rear connector W12 of the base end holding portion 16 becomes slack as it passes through the electric wire processing portion 18 between the slide portion 15 and the rear connector W12. After this movement, processing proceeds to the next step S25.

In step S25, processing takes place after the movement, in which the control unit 20 moves the slide portion 15 in the pulling direction D19 until the slide portion 15 stops at a position where the slide portion 15 pulls the electric wire W16 with a balancing force F12 that balances the holding force at the rear connector W12 of the base end holding portion 16. As a result, the electric wire W16 from the rear connector W12 of the base end holding portion 16 is tensioned with a predetermined tension between the slide portion 15 and the base end holding portion 16 as it passes through the electric wire processing portion 18. Processing such as tape wrapping during bundling in the electric wire processing portion 18 is performed with the electric wire W16 in this tensioned state.

Here, in the present embodiment, the control unit 20 may retract the slide portion 15 to a predetermined retraction position in the above-mentioned tension relaxation direction D20 after the electric wire W16 is extended by the movement of the slide portion 15. This retraction is performed to avoid interference with the electric wire processing portion 18 when performing the electric wire processing on the electric wire W16 extended by another slide portion 15.

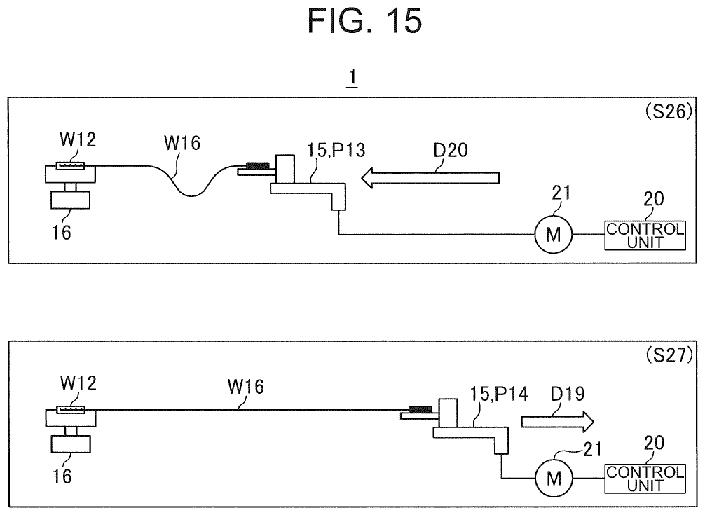

FIG. 15 is a schematic diagram illustrating step S26 and step S27 of tension control of the electric wire under the control of the control unit during execution of the wire harness manufacturing method illustrated in FIG. 12.

FIG. 15 illustrates a schematic diagram of the retraction processing of the slide portion 15 performed by the control unit 20 as a part of tension control in the wire harness manufacturing apparatus 1 according to the present embodiment.

In step S26 of this retraction processing, when the retraction period in which the electric wire processing portion 18 is anticipated to approach arrives, the control unit 20 controls the servo motor 21 to retract the slide portion 15 to the predetermined retraction position P13 in the above-mentioned tension relaxation direction D20. This retraction causes the electric wire W16 from the rear connector W12 of the base end holding portion 16 to be significantly relaxed between the slide portion 15 and the base end holding portion 16. Then, when the above-mentioned retraction period ends, processing proceeds to the next step S27.

In step S27, the control unit 20 moves the slide portion 15 to the pulling direction D19 and returns the slide portion 15 to an equilibrium position P14 before retraction. By this return of the slide portion 15, the electric wire W16 from the rear connector W12 of the base end holding portion 16 is in a state of being stretched with a predetermined tension between the slide portion 15 and the base end holding portion 16.

In the present embodiment, this tension control, including retraction processing, is performed in parallel under the control of the control unit 20 during the wire harness manufacturing method illustrated in FIG. 12.

According to the wire harness manufacturing apparatus 1 and the wire harness manufacturing method according to the embodiment described above, the following effects can be achieved. Specifically, in the present embodiment, multiple sub-harnesses W1a are supplied, and the wire harness W1 in the branch shape is manufactured by combining the multiple sub-harnesses W1a. At this time, the multiple sub-harnesses W1a, which are the material of the wire harness W1 to be manufactured, are supplied as being mounted on the sub-harness mounting plate 13. The sub-harness mounting plate 13 mounts the connector cups 12 in an attachable/detachable manner to the front connector W11 and the rear connector W12 of each sub-harness W1a. The front connector W11 and the rear connector W12 of each sub-harness W1a are transferred to the slide portion 15 and the base end holding portion 16, which are used to stretch the electric wires W16 of the multiple sub-harnesses W1a supplied in this manner, by the connector transfer mechanism 17. This connector transfer operation is performed such that the front connector W11 and the rear connector W12 are transferred together with the connector cup 12 from the sub-harness mounting plate 13 to the slide portion 15 and the base end holding portion 16. Here, multiple connector cups 12 are provided to be attached to the front connector W11 and the rear connector W12 of each sub-harness W1a so that the various front connectors W11 and the rear connectors W12 can be accommodated in an attachable/detachable manner, one each. On the other hand, the outer shapes of the multiple connector cups 12 are the same. Therefore, the slide portion 15 and the base end holding portion 16 always hold the connector cups 12 with the same outer shape regardless of the types of the front connector W11 and the rear connector W12. In addition, various branch shapes can be accommodated by changing the movement position of the slide portion 15. In other words, according to the present embodiment, it is not necessary to change the structure by replacing the slide portion 15 or the base end holding portion 16 according to the type of wire harness W1 to be manufactured, and the manufacturing task can be performed automatically while accommodating various harness types.

Here, in the present embodiment, the wire harness W1 is affixed with a part number that identifies the wire harness W1, and the wire harness manufacturing apparatus 1 is equipped with the part number obtaining portion 19 that obtains the part number affixed to the wire harness W1 to be manufactured. The connector transfer mechanism 17 transfers the front connector W11 to the slide portion 15 which is associated in one-to-one manner via the part number, and transfers the rear connector W12 to the base end holding portion 16 which is associated in one-to-one manner via the part number. After the transfer, the slide portion 15 moves to a position corresponding to the branch shape of the wire harness W1, identified by its part number, and the electric wire processing portion 18 performs the electric wire processing according to that branch shape. With this configuration, the part number of the wire harness W1 to be manufactured is obtained, and the connector transfer operation by the connector transfer mechanism 17, the movement of the slide portion 15, and the electric wire processing by the electric wire processing portion 18 correspond to the harness type associated with the part number. In other words, with the above configuration, it is possible to effectively accommodate various harness types via the part number.

Furthermore, in the present embodiment, the slide portions 15 are provided in a number greater than or equal to the number of the front connectors W11 anticipated in advance, and waits at the initial position P11 on the second end side 11b before transfer. During the transfer, only the slide portion 15 of the transfer destination that corresponds via the part number moves from the initial position P11 to the slide side attachment/detachment position P12 of the first end side 11a so that they are lined up in a line. With this configuration, by providing a larger number of slide portions 15, it is possible to increase the number of harness types that can be handled. Furthermore, slide portions 15 that do not correspond to the part number and are not used in the manufacturing of the wire harness W1 wait in the initial position P11, so they do not interfere with the electric wire processing.

Furthermore, in the present embodiment, the base end holding portions 16 are provided in a number equal to or greater than the number of the rear connectors W12 anticipated in advance, and all of the base end holding portions 16 are positioned in the array direction D12 in accordance with the processing operations based on the part numbers of each parts of the apparatus. With this configuration, by providing a larger number of base end holding portions 16, it is possible to increase the number of harness types that can be handled. Furthermore, because all of the base end holding portions 16 can move, even if there are base end holding portions 16 in a non-mounting state for the rear connector W12, the movement of the base end holding portions 16 in a mounting state is not hindered.

Furthermore, in the present embodiment, the sub-harness mounting plate 13 has the code image 132 representing the part number depicted thereon, and the part number obtaining portion 19 is a code reader that obtains the part number by the reading code image 132. With this configuration, the part number is obtained by reading the code image 132 on the sub-harness mounting plate 13 with the code reader. In other words, with the above configuration, the part number can be obtained more efficiently than, for example, a configuration in which a worker manually inputs the part number.

Furthermore, in the present embodiment, the connector transfer mechanism 17 has the holding mechanism 172 attached to the tip of the robot arm 171, which holds and detaches the front connector W11 and the rear connector W12 together with the connector cup 12. The code reader serving as the part number obtaining portion 19 is attached to the connector transfer mechanism 17 so that the code image 132 can be read when the holding mechanism 172 faces the sub-harness mounting plate 13 for connector detachment processing. With this configuration, the part number can be automatically obtained by reading the code image 132 of the sub-harness mounting plate 13 with the code reader during connector transfer by the connector transfer mechanism 17. In other words, with the above configuration, the part number can be obtained more efficiently than with a configuration in which, for example, a worker manually carries a code reader to the sub-harness mounting plate 13 to read the part number.

Furthermore, in the present embodiment, the connector transfer mechanism 17 also delivers the manufactured wire harness W1. During this delivery, the connector transfer mechanism 17 detaches the front connector W11 together with the connector cup 12 from the slide portion 15, and detaches the rear connector W12 together with the connector cup 12 from the base end holding portion 16. The connector transfer mechanism 17 then transports the manufactured wire harness W1 to the delivery location 114 and releases the front connector W11 and the rear connector W12 to deliver the manufactured wire harness W1. With this configuration, the delivery of the manufactured wire harness W1 is also automatically performed by the connector transfer mechanism 17, further reducing the workload of workers involved in harness manufacturing.

Furthermore, in the present embodiment, the delivery location 114 is provided between the movement end portion of the first end side 11a of the slide portion 15 and the installation position of the base end holding portion 16. With this configuration, the position of the delivery location 114 overlaps with the movement range during connector transfer in the connector transfer mechanism 17. Therefore, delivery of the wire harness W1 can be handled with a movement similar to that during connector transfer in the connector transfer mechanism 17, and the configuration related to delivery can be simplified.

Furthermore, in the present embodiment, the control unit 20, which functions as a tension control portion that controls the linear movement of the slide portion 15 and also controls the tension of the electric wire W16 of the sub-harness W1a, performs the following processing with respect to tension control. That is, the control unit 20 obtains an index indicating the tension of the electric wire W16, compares the index with a predetermined reference value when the slide portion 15 is at a stop, and controls the tension of the electric wire W16 by moving the slide portion 15 according to the comparison result. According to this configuration, the control unit 20 controls the movement of the slide portion 15 according to the comparison result between the index indicating the tension of the electric wire W16 and the predetermined reference value. This movement control of the slide portion 15 enables the slide portion 15 to be moved to a direction that relaxes the tension when excessive tension exceeding a reference value is likely to be applied to the electric wire W16 when the slide portion 15 is at a stop, thereby suppressing the tension applied to the electric wire W16. Furthermore, the configuration required for such tension control is the slide portion 15 originally provided for the manufacturing of the wire harness W1 and the control unit 20, which is the control configuration for it. Thus, according to the above configuration, the tension applied to the electric wire W16 can be reduced with a simple configuration.

Furthermore, in the present embodiment, the slide portion 15 stops while applying tension by pulling the electric wire W16 in pulling direction D19 with the balancing force F12 that balances the holding force of the electric wire end portion by the rear connector W12 held by the base end holding portion 16. The control unit 20 uses a value corresponding to the holding force at the base end holding portion 16 as a reference value for tension control. With this configuration, the electric wire W16 is pulled with the balancing force F12 against the holding force of the electric wire end portion at the base end holding portion 16, so that a task can be performed on the electric wire W16 when the slide portion 15 is at a stop under good workability with an appropriate tension applied to the electric wire W16.

Furthermore, in the present embodiment, the reference value for tension control is smaller than the index of temporary increase due to bundling of the electric wires W16 by the electric wire processing portion 18. With this configuration, even if tension temporarily increases when the electric wires W16 are bundled, the tension is already reflected in the reference value for tension control, so the increase in tension can be effectively reduced.

Furthermore, in the present embodiment, when the index related to tension exceeds a reference value, the control unit 20 moves the slide portion 15 in the tension relaxation direction D20 by a relaxation distance L11 longer than the distance required for the index to fall below the reference value. After that movement, the control unit 20 moves the slide portion 15 in the pulling direction D19 until the electric wire W16 stops while being pulled by the balancing force F12 against the holding force at the base end holding portion 16. With this configuration, when the index exceeds the reference value, the slide portion 15 is first moved by the above-mentioned long relaxation distance L11, and the tension of the electric wire W16 is significantly reduced. Then, the slide portion 15 moves to a position where the electric wire W16 stops while being pulled by the balancing force F12 against the holding force, so that the electric wire W16 is stretched with an appropriate tension. Thus, the above-mentioned configuration effectively achieves both rapid relaxation when tension increases and subsequent good workability for the electric wire W16.

Furthermore, in the present embodiment, when a predetermined retraction period arrives, the control unit 20 retracts the slide portion 15 to the retraction position P13, and when the retraction period ends, the control unit 20 returns the slide portion 15 to the equilibrium position P14 before retraction. According to this configuration, for example, when the slide portion 15 or the electric wire W16 stretched by the slide portion 15 interferes with a peripheral task, the slide portion 15 can be retracted together with the electric wire W16, so that the peripheral task can be performed with good workability.

The above-described embodiment merely illustrates a representative form of the wire harness manufacturing apparatus and the wire harness manufacturing method. The wire harness manufacturing apparatus and the wire harness manufacturing method are not limited to the above embodiment and can be modified in various ways.

For example, in the above-described embodiment, the wire harness W1 that is mounted and routed in an automobile is illustrated as an example of the wire harness to be manufactured. However, the wire harness is not limited thereto, and may be a wire harness other than that for mounting in an automobile.

In the above-described embodiment, the wire harness W1 illustrated in FIG. 2 is an example of the wire harness to be manufactured. However, the wire harness is not limited thereto, and as long as it has a branch shape, the specific number of branches and the like are not important.

Furthermore, in the above-described embodiment, as an example of an electric wire processing portion, the electric wire processing portion 18 is given, which performs bundling and tape wrapping of the electric wire W16 as the electric wire processing. However, the electric wire processing portion is not limited thereto, and may perform the electric wire processing including processing to selectively bundle electric wires and form a branch shape, and may perform tthe electric wire processing including other processing. In other words, in addition to the above processing, the electric wire processing portion may perform the electric wire processing such as, for example, attachment of exterior members such as corrugated tubes and attachment of fixing clips to fix a wire harness to a predetermined fixed location.

Furthermore, in the above-described embodiment, as an example of a wire harness manufacturing apparatus, the wire harness manufacturing apparatus 1 is illustrated, which is equipped with the part number obtaining portion 19 and performs various processing related to the manufacturing of the wire harness to be manufactured according to the obtained part number. However, the wire harness manufacturing apparatus is not limited thereto, and may be an apparatus that does not have the part number obtaining portion and in which a worker manually sets manufacturing conditions such as the branch shape of the wire harness to be manufactured. However, as described above, according to a configuration in which the part number is obtained by the part number obtaining portion 19 and the wire harness is manufactured by processing according to that part number, it is possible to effectively respond to various harness types.

Furthermore, in the above-described embodiment, as an example of slide portions, the slide portions 15 are illustrated, which are provided in a number equal to or greater than the number of the front connectors W11 anticipated in advance, waits at the initial position P11, and only the one corresponding to the part number moves to the slide side attachment/detachment position P12. However, the slide portions are not limited thereto, and may be provided in the same number as the anticipated number of the front connectors, and all slide portions may move to the slide side attachment/detachment position. Alternatively, the slide portions may be provided in a number greater than the anticipated number, but all slide portions may move to the slide side attachment/detachment position. However, as described above, according to a configuration in which only the one corresponding to the part number among the slide portions 15 that are provided in the number greater than the anticipated number moves to the slide side attachment/detachment position P12, it is possible to increase the number of harness types that can be handled. Also, according to this configuration, slide portions 15 that do not correspond to the part number wait in the initial position P11, so they do not interfere with electric wire processing, as described above.

Furthermore, in the above-described embodiment, as an example of base end holding portions, base end holding portions 16 are provided in a number equal to or greater than the number of the rear connectors W12 anticipated in advance, and all of them are positioned in positions corresponding to the processing operations based on the part number. However, the base end holding portions are not limited thereto, and may be provided in the same number as the expected number of the rear connectors, and may be fixed in a predetermined position so that the array direction is immovable regardless of the part number and the like. However, as described above, if all of the base end holding portions 16 that are provided in a number greater than the anticipated number are positioned in positions corresponding to the part number, the number of harness types that can be handled can be increased. Also, as described above, with this configuration, since all of the base end holding portions 16 are positioned in positions corresponding to the part number, even if there is a rear connector W12 in a non-mounting state, the movement of other base end holding portions 16 in a mounting state is not hindered.

Furthermore, in the above-described embodiment, as an example of a wire harness manufacturing apparatus, the wire harness manufacturing apparatus 1 is illustrated in which the code image 132 representing the part number is depicted on the sub-harness mounting plate 13, and the part number obtaining portion 19 is a code reader. However, the wire harness manufacturing apparatus is not limited thereto, and the method of obtaining the part number may be manual input by a worker and the like. However, as described above, if the code image 132 is read by the code reader to obtain the part number, the part number can be obtained efficiently.

Furthermore, in the above-described embodiment, as an example of a wire harness manufacturing apparatus, the wire harness manufacturing apparatus 1 is illustrated in which the code reader serving as the part number obtaining portion 19 is attached to the connector transfer mechanism 17 that performs the connector transfer operation. However, the wire harness manufacturing apparatus is not limited thereto, and may be configured such that the code reader serving as the part number obtaining portion is provided separately from the connector transfer mechanism in a portable manner, and a worker manually carries the code reader to read the part number. However, as described above, a configuration in which the code reader serving as the part number obtaining portion 19 is attached to the connector transfer mechanism 17 makes it possible to efficiently obtain the part number during connector transfer.

Furthermore, in the above-described embodiment, as an example of a wire harness manufacturing apparatus, the wire harness manufacturing apparatus 1 is illustrated in which the connector transfer mechanism 17 transports the manufactured wire harness W1 to the delivery location 114 to deliver it. However, the wire harness manufacturing apparatus is not limited thereto, and a separate mechanism for delivery of manufactured wire harnesses may be provided, or delivery may be performed manually by workers. However, as described above, when the connector transfer mechanism 17, which performs connector transfer operation in the early stage of harness manufacturing, also takes charge of delivery of the manufactured wire harness W1, the workload of workers involved in harness manufacturing can be further reduced.

Furthermore, in the above-described embodiment, as an example of a wire harness manufacturing apparatus, the wire harness manufacturing apparatus 1 is illustrated in which the delivery location 114 is provided between the movement end portion of the slide portion 15 and the installation position of the base end holding portion 16. However, the wire harness manufacturing apparatus is not limited thereto, and the specific position of the delivery location is not important. However, as described above, when the delivery location 114 is provided between the movement end portion of the slide portion 15 and the installation position of the base end holding portion 16, the configuration related to delivery can be simplified.

Furthermore, in the above-described embodiment, as an example of a wire harness manufacturing apparatus, the wire harness manufacturing apparatus 1 is illustrated that is equipped with the control unit 20 that functions as a tension control portion that controls the tension of the electric wire W16 during harness manufacturing by moving the slide portion 15. However, the wire harness manufacturing apparatus is not limited thereto, and tension control of the electric wire W16 during harness manufacturing may not be performed in particular. However, as described above, when the control unit 20 that performs such tension control is provided, the tension applied to the electric wire W16 can be reduced with a simple configuration.

Furthermore, in the above-described embodiment, as an example of a wire harness manufacturing apparatus, the wire harness manufacturing apparatus 1 is illustrated in which the control unit 20 sets a value corresponding to the holding force at the base end holding portion 16 as a reference value and performs tension control based on a comparison with this reference value. However, the wire harness manufacturing apparatus is not limited thereto, and any value can be set as the reference value for tension control. However, as described above, according to tension control that sets a value corresponding to the holding force at the base end holding portion 16 as the reference value, a task can be performed on the electric wire W16 when the slide portion 15 is stopped under good workability with an appropriate tension applied to the electric wire W16.

Furthermore, in the above-described embodiment, as an example of a reference value for tension control, a reference value smaller than the index that temporarily rises due to bundling of the electric wires W16 by the electric wire processing portion 18 is illustrated. However, the reference value for tension control is not limited thereto, and any reference value can be used. However, as described above, when a reference value smaller than the index that temporarily rises due to bundling of the electric wires W16 is used, the rise in tension when the electric wires W16 are bundled can be effectively reduced.

Furthermore, in the above-described embodiment, as an example of tension control, tension control is exemplified in which, when the tension index of the electric wire W16 exceeds the reference value, the slide portion 15 is moved in the tension relaxation direction D20 by the relaxation distance L11 longer than the distance required for the index to fall below the reference value. However, tension control is not limited thereto, and may be control such as immediately stopping the movement of the slide portion 15 when the index falls below the reference value. However, as described above, according to the tension control that moves the slide portion 15 by the long relaxation distance L11 as described above, it is possible to effectively achieve both rapid relaxation when tension rises and ensuring good workability for the electric wire W16 thereafter.

Furthermore, in the above-described embodiment, as an example of tension control, tension control is illustrated in which the slide portion 15 is retracted to the retraction position P13 when the retraction period arrives, and the slide portion 15 is returned to the equilibrium position P14 before the retraction when the retraction period ends. However, tension control is not limited thereto, and the retraction period as described above may not be specifically set. However, as described above, with the retraction period being set and the retraction during the period, the slide portion 15 can be retracted together with the electric wire W16, and the related tasks can be performed with good workability.

### LIST OF REFERENCE SIGNS

1 wire harness manufacturing apparatus
11 apparatus frame
11a first end side
11b second end side
12 connector cup
13 sub-harness mounting plate
14 plate fixing portion
15 slide portion
16 base end holding portion
17 connector transfer mechanism
18 electric wire processing portion
19 part number obtaining portion
20 control unit
21 servo motor
111 slide rail
112 electric wire processing rail
113 base end rail
114 delivery location
115 mechanism base
121 accommodation chamber
122 passage groove
123 transfer locking groove
131 cup holding portion
131a cup holding arm
132 code image
141 screw
151 slide side cup holding portion
151a, 161a cup receiving recess
151b, 161b electric wire passage hole
151c, 161c notch
152 slide connecting portion
161 base end cup holding portion
162 base end connecting portion
171 robot arm
172 holding mechanism
172a L-shaped angle
172b arm mechanism
172b-1 holding arm
181 mechanism frame
182 front bundle mechanism
182a, 183a bundle arm
183 rear bundle mechanism
184 tape wrapping mechanism
184a tape reel
D11 slide direction
D12 array direction
D13 accommodation chamber depth direction
D14 electric wire extension direction
D15 cup attachment/detachment direction
D16 slide side rotation mounting direction
D17 base end rotation mounting direction
D18 angle longitudinal direction
D19 pulling direction
D20 tension relaxation direction
F11 driving force
F12 balancing force
F13 upward driving force
L11 relaxation distance
P11 initial position
P12 slide side attachment/detachment position
P13 retraction position
P14 equilibrium position
S11 plate mounting step
S12 part number obtaining step
S13 pre-connector-transfer moving step
S14 connector transfer step
S15 electric wire processing step
S16 pre-delivery moving step
S17 delivery step
W1 wire harness
W1a sub-harness
W11 front connector
W12 rear connector
W13 tape-wrapped portion
W16 electric wire
W131 tape

What is claimed is:

1. A wire harness manufacturing apparatus comprising:
a plurality of connector cups having a same outer shape as each other and configured to accommodate, one by one in a detachable manner, a plurality of connectors provided on one-end side and one or more connectors provided on the other-end side of a wire harness to be manufactured in which a branch shape is formed by combining a plurality of sub-harnesses;
a sub-harness mounting plate on which the plurality of sub-harnesses are mounted while the connector cups are attached to the connectors included in the sub-harnesses in a detachable manner;
a plate fixing portion to which the sub-harness mounting plate is attached in a detachable manner;
a plurality of slide portions respectively holding, via the connector cups, a plurality of one-end side connectors that are provided on the one-end side among the plurality of connectors, the plurality of slide portions configured to line up in parallel with each other in a predetermined array direction to perform a linear movement in a slide direction between a first end side and a second end side,
one or more base end holding portions installed, in an immobile manner at least in the slide direction, on the first end side that is a base end of the linear movement, each of the base end holding portions configured to hold, via the connector cup, one of a plurality of other-end side connectors that are provided on the other-end side among the plurality of connectors;
a connector transfer mechanism configured to detach the one-end side connector and the other-end side connector together with the connector cups from the sub-harness mounting plate attached to the plate fixing portion, transfer the one-end side connector together with the connector cup to the slide portion, and transfer the other-end side connector together with the connector cup to the base end holding portion; and
an electric wire processing portion configured to perform electric wire processing including processing to form the branch shape by selectively bundling electric wires of the plurality of sub-harnesses stretched, by the linear movement, between the plurality of slide portions and the one or more base end holding portions.

2. The wire harness manufacturing apparatus according to claim 1, wherein the wire harness is affixed with a part number that identifies the wire harness,
wherein the wire harness manufacturing apparatus further comprises a part number obtaining portion that obtains the part number affixed to the wire harness to be manufactured,
the connector transfer mechanism is configured to transfer the one-end side connector detached together with the connector cup from the sub-harness mounting plate to the slide portion associated in one-to-one manner via the part number, and transfer the other-end side connector detached together with the connector cup from the sub-harness mounting plate to the base end holding portion associated in one-to-one manner via the part number,
the slide portion having received the transferred one-end side connector moves in the slide direction to a position corresponding to the branch shape of the wire harness identified by the part number, and
the electric wire processing portion performs the electric wire processing according to the branch shape of the wire harness identified by the part number.

3. The wire harness manufacturing apparatus according to claim 2, wherein the plurality of slide portions are provided in a number equal to or greater than a number of one-end side connectors of the wire harness anticipated in advance for the wire harnesses to be manufactured,
before transfer by the connector transfer mechanism, the plurality of slide portions wait at an initial position on the second end side, and
during transfer by the connector transfer mechanism, only the slide portions associated as transfer destination of the one-end side connectors via the part number move from the initial position to line up in a line in the array direction at a slide side attachment/detachment position on the first end side.

4. The wire harness manufacturing apparatus according to claim 2, wherein the one or more base end holding portions are provided in a number equal to or greater than a number of other-end side connectors of the wire harness anticipated in advance for the wire harness to be manufactured,
all the base end holding portions are positioned in the array direction at positions according to processing operations based on the part number performed by the connector transfer mechanism and the electric wire processing portion.

5. The wire harness manufacturing apparatus according to claim 2, wherein a code image indicating the part number is depicted on the sub-harness mounting plate, and
the part number obtaining portion is a code reader configured to obtain the part number by reading the code image.

6. The wire harness manufacturing apparatus according to claim 5, wherein the connector transfer mechanism is attached with a holding mechanism that is attached to a tip of a robot arm and that is configured to hold and detach the plurality of connectors in one-to-one manner together with the plurality of connectors cups attached to the sub-harness mounting plate, and
the code reader serving as the part number obtaining portion is attached to the connector transfer mechanism so that the code image can be read when the holding mechanism of the connector transfer mechanism faces the sub-harness mounting plate for detachment of the connector.

7. The wire harness manufacturing apparatus according to claim 1, wherein the connector transfer mechanism detaches, from the slide portion, the one-end side connector of the manufactured wire harness, having been subjected to the electric wire processing by the electric wire processing portion, together with the connector cup, detaches one or more other-end side connectors together with the connector cup from the base end holding portion, transports the manufactured wire harness to a predetermined delivery location, and releases the one-end side connector and the one or more other-end side connector in the delivery location to deliver the manufactured wire harness.

8. The wire harness manufacturing apparatus according to claim 7, wherein the one or more base end holding portions are provided to line up in a line in the array direction, with a spacing in the slide direction between a movement end portion on the first end side of the slide portion and the one or more base end holding portions, and
the delivery location is provided between the movement end portion of the slide portion and an installation position of the base end holding portions.

9. The wire harness manufacturing apparatus according to claim 1, further comprising:
a tension control unit configured to control the linear movement of the slide portion, obtain an index indicating tension of an electric wire of the sub-harness connected to the one-end side connector moving together with the slide portion, compare the index with a predetermined reference value when the slide portion is at a stop, and move the slide portion according to the comparison result.

10. A wire harness manufacturing method comprising, using the wire harness manufacturing apparatus according to claim 1:
a plate mounting step of attaching, to the plate fixing portion, the sub-harness mounting plate on which the plurality of sub-harnesses are mounted while the connector cups are attached to the connectors included in the sub-harnesses in a detachable manner;
a connector transfer step in which the connector transfer mechanism detaches the one-end side connector and the other-end side connector together with the connector cups from the sub-harness mounting plate attached to the plate fixing portion, transfers the one-end side connector together with the connector cup to the slide portion, and transfers the other-end side connector together with the connector cup to the base end holding portion; and
an electric wire processing step in which the electric wire processing portion performs electric wire processing including processing to form the branch shape by selectively bundling electric wires of the plurality of sub-harnesses stretched, by the linear movement, between the plurality of slide portions and the one or more base end holding portions.
